(19) United States
(12) Patent Application Publication
(10) Pub. No.: US 2007/0088698 A1
(43) Pub. Date: Apr. 19, 2007

(54) Information processing apparatus, karaoke apparatus, and recording medium

(75) Inventors: Yuichi Hatsumi, Tokyo (JP); Jin Tomita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD.

(21) Appl. No.: 11/582,887

(22) Filed: Oct. 18, 2006

(30) Foreign Application Priority Data
Oct. 19, 2005 (JP) 2005-303992

(51) Int. Cl. G06F 17/30; G06F 17/00

(52) U.S. Cl. 707/6; 707/3; 715/816

(57) ABSTRACT

Upon switching operation of a remote control device, CPU 11 in a karaoke system judges whether an entered singer's name or song title consists of a single character or the entered singer's name or song title consists of two and more characters. When the entered singer's name or song title consists of a single character, a prefix search process is executed to search for information starting with the entered character. When the entered singer's name or song title consists of two and more characters, a partial match search process is executed to search for information including a character string of the entered characters. Therefore, a user is not required to set whether to execute the prefix search or to execute the partial match search, and is allowed to search for his or her desired information, only by entering a single character.

### CROSS-REFERENCE TO RELATED APPLICATIONS

This application is based on and claims the benefit of priority from the prior Japanese Patent Application No. 2005-303992, filed Oct. 19, 2005, the entire contents of which are incorporated herein by reference.

### BACKGROUND OF THE INVENTION

1. Field of the Invention

The present invention relates to an information processing apparatus, karaoke apparatus, and recording medium, and more specifically, to an information processing apparatus and karaoke apparatus, which execute a prefix search process or a partial match search process to search for information base on input data, and to a recording medium on which a program for searching for information is recorded.

2. Description of the Related Art

Apparatuses are widely used, which execute a prefix search or a partial match search to search for certain information. For example, JP 2003-91548 A (Patent document 1) discloses a book search system in a library, which is connected via the internet with a user client device used by a library user and server equipment for searching for a certain book or magazine in a catalog database.

The server equipment is arranged to allow to access to a catalog database, in which catalog information including bibliographic data relating to books and magazines is registered, and to allow a library user to access to a search database to search through the catalog information of books or magazines available for the library user.

Further, the server equipment is arranged to retrieve the registered catalog information from the catalog database and to register the retrieved catalog information into the search database. The server equipment is further arranged to search through the catalog information registered in the search database based on a searching condition entered from the user client device and to supply the search results to the user client device.

In this case, when a character series entered as a searching term matches with a character series included in the bibliographic data registered in the search database, or when the entered character series matches with the leading portion or trailing portion of the bibliographic data, the server equipment searches for the catalog information corresponding to the bibliographic data having such character series. In the Patent document 1 is given no description as to how to set the searching condition, under which such search is to be executed. But in conventional search systems, the user is required to previously set whether a partial match search, a prefix search, or a suffix search is to be executed,

As another example of the information search system, a karaoke system is referred to. When song information is searched in the karaoke system, full characters of a singer's name or song title are not entered but sometimes some characters of a portion of them are entered for a searching purpose. JP Hei9-114474 A (Patent document 2) discloses an apparatus for selecting karaoke songs. In the apparatus, an electronic book, in which relationships between song titles and song code numbers are recorded, is searched through based on an entered song code number, and information for selecting appropriate song titles is recorded on IC card. This IC card is available in another karaoke house or can be used with anther karaoke machines.

In this case, the number of characters of a song title to be written on IC card is limited to the minimum numbers of characters (twelve characters) which are enough for selecting and designating a certain song title from among song titles to be designated, even if some characters in the leading portion of a song title are entered in place of the full characters of the song title.

The conventional apparatus is arranged such that information is searched for based on a character series including plural characters, and the user is required to select one searching method out of a prefix search and partial match search to be made to search for his or her desired information. But it will be troublesome for the users to set every searching operation whether to execute the prefix search or the partial match search. For example, it will place a burden on users to enter plural characters or set whether to execute the prefix search or partial match search in a dark and noisy surrounding, such as in karaoke places, and the users can easily operate the karaoke machine in error.

The present invention has been made to solve the problems involved in the conventional information searching apparatuses, and has an object to provide a technology which can search for information without requiring a user every searching operation to set whether to execute a partial match search or a prefix search, and can search for information, even if only a signal character is entered.

### SUMMARY OF THE INVENTION

According to one aspect of the invention, there is provided an information processing apparatus, which judges whether entered data consists of any one of a single character, a single numeral and a single symbol, or the entered data consists of any one of a series of two and more characters, a series of two and more numerals, a series of two and more symbols, and a combination of a character, numeral, and symbol, and which executes a prefix search to search for desired information, when it is determined that the data entered data consists of one of a single character, a single numeral and a single symbol, and executes a partial match search to search for the desired information, when it is determined that the entered data consists of one of a series of two and more characters, a series of two and more numerals, a series of two and more symbols, and a combination of a character, numeral, and symbol.

According to another aspect of the invention, there is provided karaoke equipment for searching for a song based on a song title, which judges whether entered data consists of any one of a single character, a single numeral and a single symbol, or the entered data consists of any one of a series of two and more characters, a series of two and more numerals, a series of two and more symbols, and a combination of a character, numeral, and symbol, and which executes a prefix search process to search through plural song titles stored therein for an appropriate song title, when it is determined that the entered data consists of one of a single character, a single numeral and a single symbol, and executes a partial match search process to search through plural song titles stored therein for an appropriate song title, when it is determined that the entered data consists of one of a series of two and more characters, a series of two and more numerals, a series of two and more symbols, and a combination of a character, numeral, and symbol, and reads out song data corresponding to the searched song title.

According to still another aspect of the invention, there is provided a computer readable recording medium, on which a computer program is recorded, the computer program for making a computer execute a process which comprises judging whether entered data consists of any one of a single character, a single numeral and a single symbol, or the entered data consists of any one of a series of two and more characters, a series of two and more numerals, a series of two and more symbols, and a combination of a character, numeral, and symbol; and executing a prefix search process to search for desired information, when it is determined that the entered data consists of one of a single character, a single numeral and a single symbol; and executing a partial match search process to search for desired information, when it is determined that the entered data consists of one of a series of plural characters, a series of plural numerals, a series of plural symbols, and a combination of a character, numeral, and symbol.

According to yet another aspect of the invention, there is provided a recording medium for used with a karaoke apparatus, on which medium a program is recorded, the program, when installed on the karaoke apparatus, making the karaoke apparatus execute a process which comprises judging whether entered data consists of any one of a single character, a single numeral and a single symbol, or the entered data consists of any one of a series of two and more characters, a series of two and more numerals, a series of two and more symbols, and a combination of a character, numeral, and symbol; executing a prefix search process to search through song data stored therein for a desired song title based on the entered data, when it is determined that the data entered from the input unit consists of one of a single character, a single numeral and a single symbol; executing a partial match search process to search through the song data stored therein for a desired song title based on the entered data, when it is determined that the entered data consists of one of a series of plural characters, a series of plural numerals, a series of plural symbols, and a combination of a character, numeral, and symbol; and reading out song data corresponding to the found song title.

### BRIEF DESCRIPTION OF THE DRAWINGS

FIG. 1 is an external view of a remote control device of a karaoke system according to an embodiment of the present invention.

FIG. 2 is a block diagram illustrating a circuit configuration of the karaoke system according to the embodiment of the present invention.

FIG. 3 is a flow chart of a main routine process executed by CPU shown in FIG. 2.

FIG. 4 is a flow chart of a song search process in the main routine process of FIG. 3.

FIG. 5 is a flow chart of a song search process following to the flow chart of FIG. 4.

FIG. 6 is a flow chart of a song search process following to the flow chart of FIG. 4.

FIG. 7 is a flow chart of a song search process following to the flow chart of FIG. 6.

FIGS. 8A to 8D are views illustrating an example of a prefix search and an example of a partial match search.

FIG. 9 is a flow chart of a performance process in the main routine process of FIG. 3.

### DETAILED DESCRIPTION OF PREFERRED EMBODIMENTS

Now, as an example of an information processing apparatus of the present invention, an embodiment of a karaoke system will be described herein after with reference to the accompanying drawings.

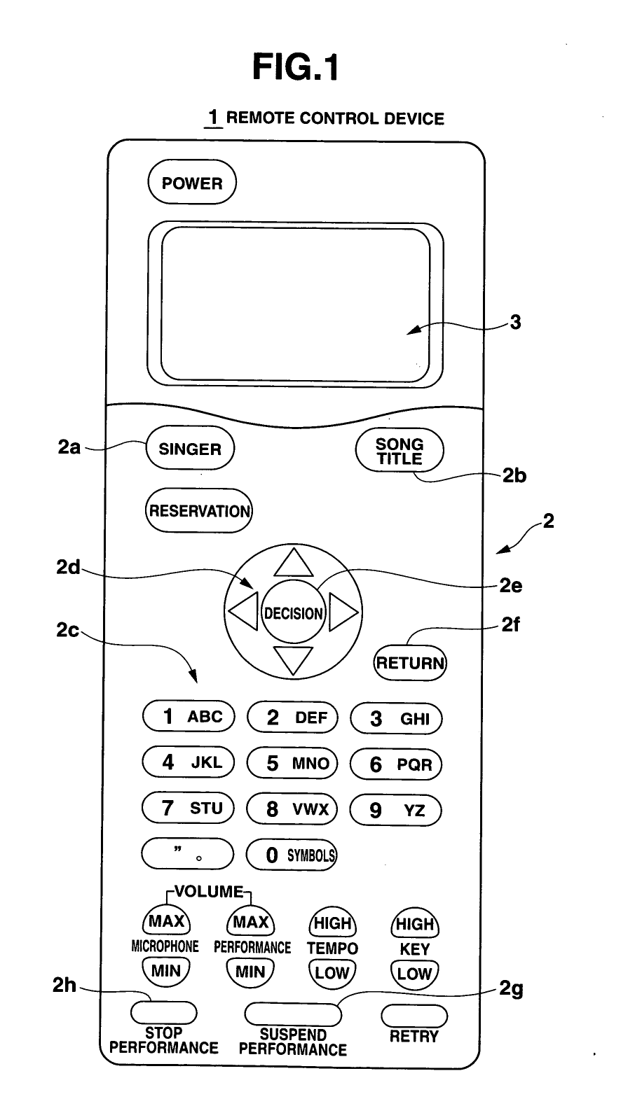

FIG. 1 is a view illustrating an external view of a remote control device 1 of the karaoke system. As illustrated in FIG. 1, the remote control device 1 is provided with a switch unit 2 and display unit 3. The switch unit 2 includes various sorts of switches which are operated for karaoke performance, for example, such as a singer's name switch 2a, song title switch 2b, character input switch 2c for entering characters, numerals, and symbols, cursor switch 2d, decision switch 2e, return switch 2f, performance switch (which is also used as a suspension switch) 2g, performance stop switch 2h, and the like. The display unit 3 comprises LCD (liquid crystal display), and displays characters, numerals and symbols concerning karaoke performance thereon.

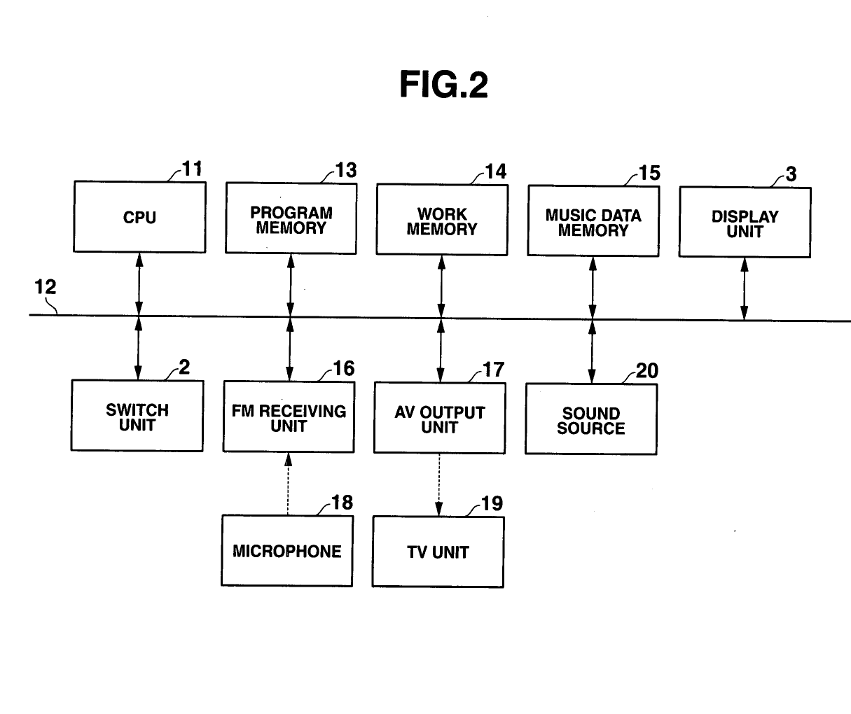

FIG. 2 is a block diagram illustrating a circuit configuration of the embodiment of the karaoke system according to the present invention.

In the karaoke system illustrated in FIG. 2, CPU 11 is connected with the switch unit 2 and display unit 3 illustrated in FIG. 1 through a system bus 12, and further connected with a program memory 13, work memory 14, music data memory 15, FM receiving unit 16, AV (audio/visual) output unit 17, and sound source 20. CPU 11 exchanges data with these units, and controls whole operation of the karaoke system.

On the program memory 13 are previously stored a data processing program and a control program to be executed by CPU 11, and initial data. On the work memory 14 is temporarily stored data to be processed by CPU 11. On the music data memory 15 are stored a database of karaoke songs including singer's name data, song title data, performance data for each song (accompaniment data), lyrics data, and back ground image data. The sound source 20 generates music waveform data based on the performance data read out from the music data memory 15. FM receiving unit 16 has a function of receiving FM radio wave sent from a microphone 18 and of demodulating the voice of a singer included in the received FM radio signal, and further has a function of converting the demodulated analog voice signal into a digital signal and of supplying the digital signal to CPU 11. AV output unit 17 supplies TV unit 19 connected thereto with a singer's name, song title, lyrics, and back ground image data, which have been searched for in the music data memory 15 in accordance with the song selected by the remote controller 1, and mixes the music waveform data and voice data entered from the microphone 18, thereby converting digital data into analog data and outputting an analog signal.

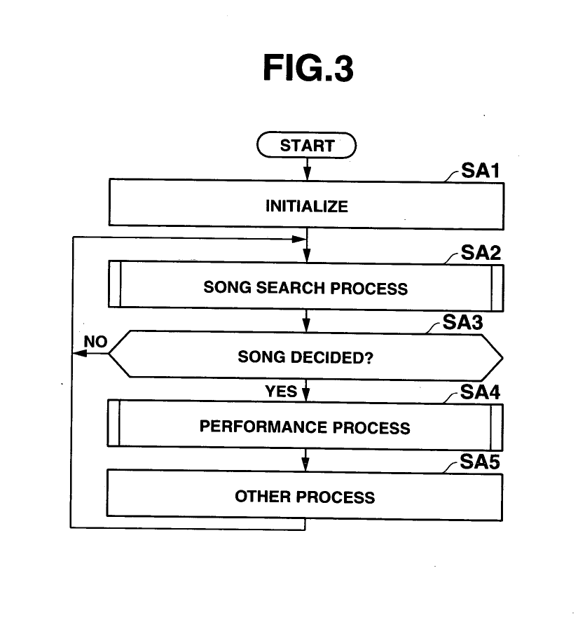

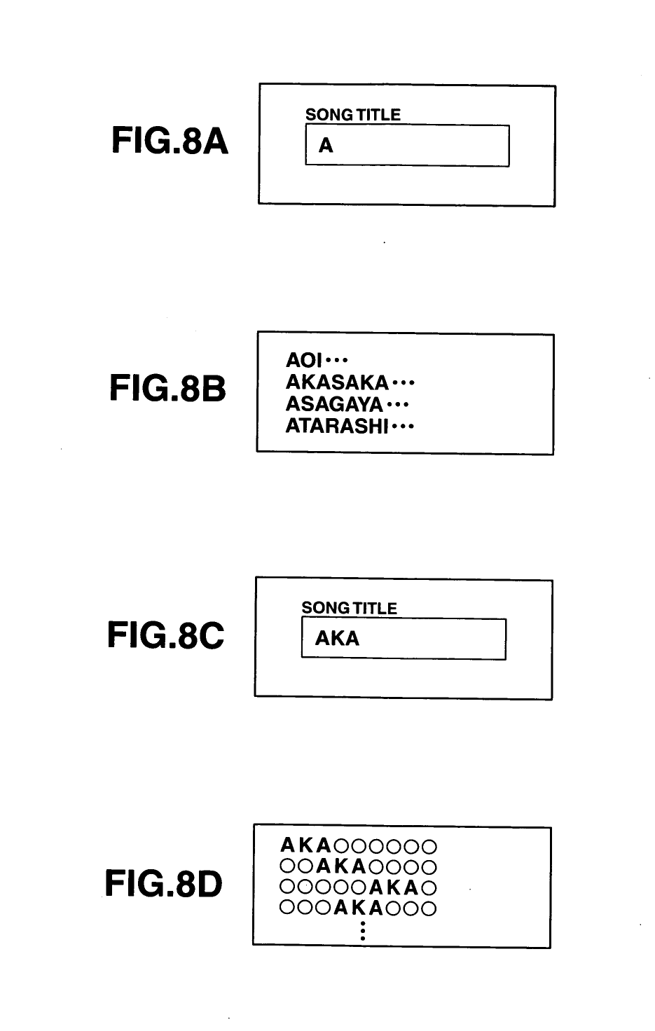

Now, operation of the karaoke system illustrated in FIG. 1 will be described with reference to flow charts of FIGS. 3 to 7, and FIG. 9, which are executed by CPU 11, and display screens shown in FIGS. 8A to 8D.

FIG. 3 is a flow chart of a main routine process. A predetermined initializing process is executed at step SA1. Then, a song search process is executed at step SA2. At the following step SA3, it is judged whether or not the song which has been searched for in the song search process at step SA2, is determined to be performed by operation of the decision switch 2e of the remote control device 1. When the song to be performed is determined (YES at step SA3), the performance process is executed with respect to the determined song at step SA4. Then, other process is executed at step SA5. Thereafter, operation returns to step SA2 and the above processes are repeatedly executed.

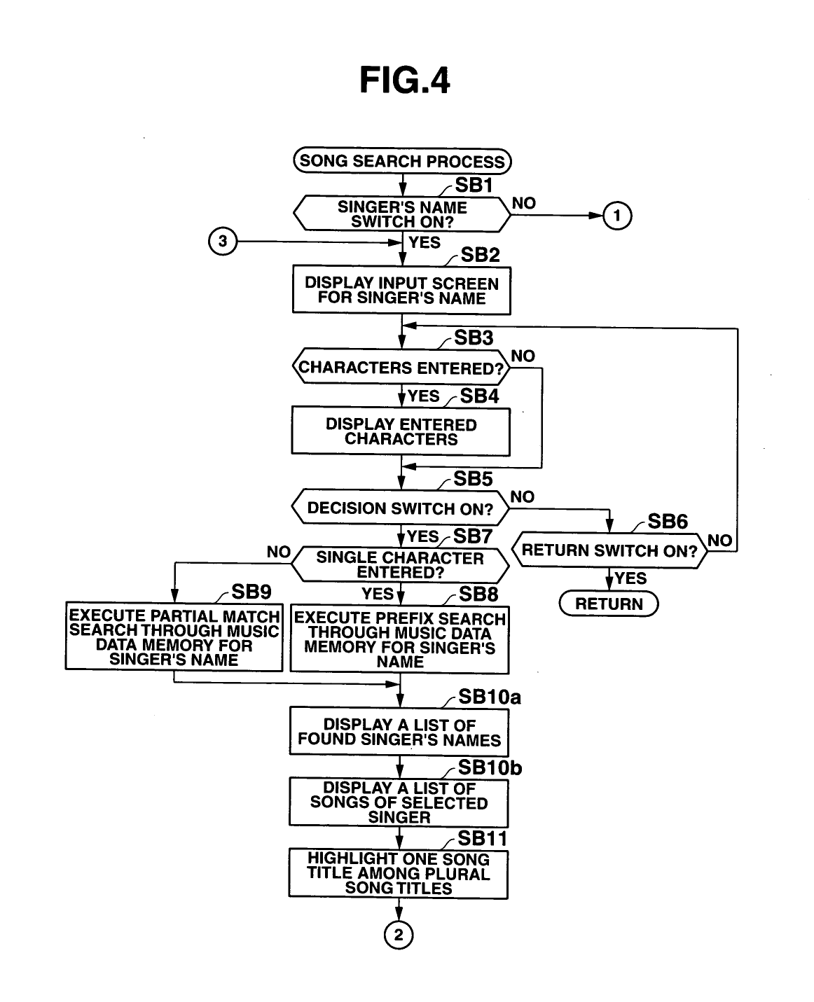

The song search process executed at step SA2 in the main routine process of FIG. 3 is illustrated in detail in FIGS. 4 to 7.

In the flow chart of FIG. 4, it is judged at step SB1 whether or not the singer's name switch 2a of the remote control device 1 shown in FIG. 1 has been operated. When the singer's name switch 2a is operated (YES at step SB1), an input screen for entering a singer's name is displayed on the display unit 3 at step SB2. It is judged at step SB3 whether or not characters have been input. When characters have been entered (YES at step SB3), the entered characters are displayed on the display unit 3 at step SB4. Then, it is judged at step SB5 whether or not the decision switch 2e has been turned on. When the decision switch 2e is not turned on (NO at step SB5), operation advances to step SB6, where it is judged whether or not the return switch 2f has been turned on. When the return switch 2f has been turned on (YES at step SB6), the operation returns to the main routine process. When the return switch 2f is not turned on (NO at step SB6), the operation returns to step SB3, where it is judged again whether or not characters have been entered.

Meanwhile, when it is determined at step SB5 that the decision switch 2e has been turned on (YES at step SB5), it is judged at step SB7 whether or not only a single character has been entered. When it is determined at SB7 that a single character has been entered (YES at step SB7), a prefix search process is executed, at step SB8, to search through the data base stored on the music data memory 15 for a singer's name whose first character matches with the single character entered at step SB3. On the other hand, when it is determined at step SB7 that two and more characters (character string) have been entered (NO at step SB7), a partial match search process is executed, at step SB9, to search through the data base stored on the music data memory 15 for a singer's name whose character string partially match with the character string entered at step SB3. When the singer's names have been found at step SB8 or at step SB9, a list of singer's names is displayed on the display unit 3 at step SB10a. A list of songs of the singer selected by operation of the cursor switch 2d and decision switch 2e is displayed at the following step SB10b, and one of the displayed songs (for example, the first song in the list of songs) is highlighted, or displayed in color different from others at step SB11.

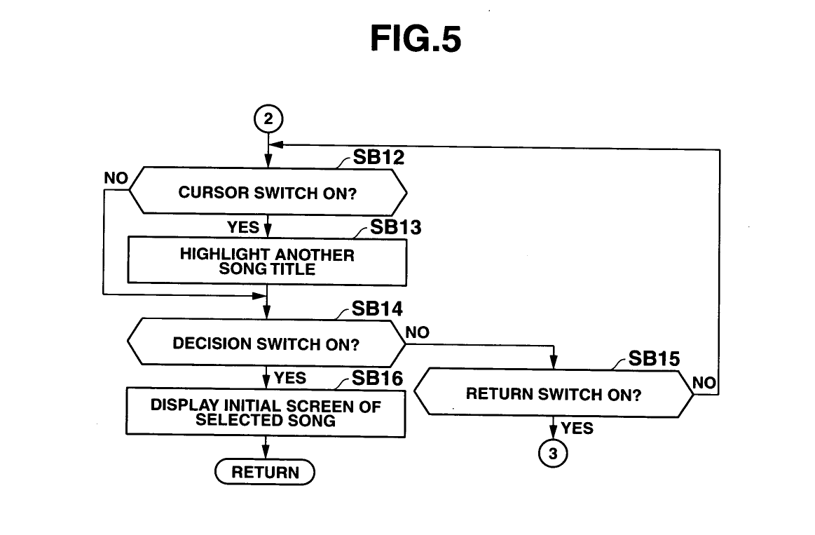

Then, it is judged at step SB 12 in FIG. 5 whether or not the cursor switch 2d has been operated. When the cursor switch 2d has been operated, another song among the list of songs is highlighted at step SB13. When the cursor switch 2d has not been operated (NO at step SB12), or after another song is highlighted at SB13, it is judged at step SB14 whether or not the decision switch 2e has been operated. When the decision switch 2e has not been operated (NO at step SB14), operation advances to step SB15, where it is judged whether or not the return switch 2f has been operated. When the return switch 2fhas been operated (YES at step SB15), operation returns to step SB2 in FIG. 4, where the input screen for entering a singer's name is displayed again. When it is determined at step SB15 that the return switch 2f has not been operated (NO at step SB15), operation returns to step SB12, where it is judged again whether or not the cursor switch 2d has been turned on. When it is determined at step SB12 that the cursor switch 2d has not been turned on (NO at step SB12), operation advances to step SB14, where it is judge whether or not the decision switch 2e has been operated. When the decision switch 2e has been operated (YES at step SB14), an initial screen of the selected song, including the singer's name, the title of the song and a back ground image is displayed at step SB16. Then, operation returns to the main routine process shown in FIG. 3.

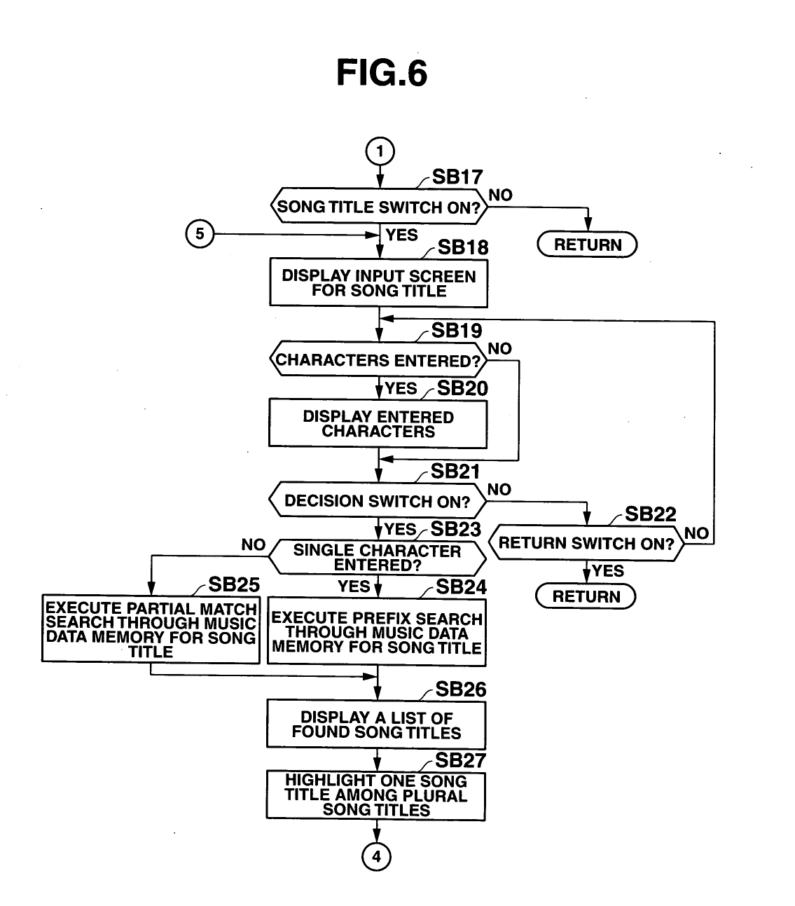

Meanwhile, when it is determined at step SB 1 in FIG. 4 that the singer's name switch 2a has not been turned on (NO at step SB1), operation advances to step SB17 (FIG. 6), where it is judged whether or not the song title switch 2b has been operated. When the song title switch 2b has been operated (YES at step SB17), an input screen for entering a song title is displayed at step SB18. Then, it is judged at step SB19 whether or not any character has been entered. When characters have been entered (YES at step SB19), the entered characters are displayed at step SB20. Then, it is judged at step SB21 whether or not the decision switch 2e has been operated. When it is determined at step SB21 that the decision switch 2e is not operated (NO at step SB21), operation advances to step SB22, where it is judged whether or not the return switch 2f has been operated. When the return switch 2f has been operated (YES at step SB22), operation returns to the main routine process (FIG. 3). Meanwhile, when the return switch 2f has not been operated (NO at step SB22), then, operation returns to step SB19, where it is judged again whether or not any character has been entered.

Meantime, when the decision switch 2e has been operated at step SB21 (YES at step SB21), it is judged at step SB23 whether a single character or two and more characters have been entered. When it is determined at step SB23 that a single character has been entered (YES at step SB23), a prefix search process is executed at step SB24, to search through the data base stored on the music data memory 15 for a song title whose first character matches with the single character entered at step SB19. Meanwhile, when it is determined at step SB23 that two and more characters (character string) have been entered (NO at step SB23), a partial match search process is executed at step SB25, to search through the data base stored on the music data memory 15 for a song title whose character string partially match with the character string entered at step SB19. When the song titles have been found at step SB24 or at step SB25, a list of song titles is displayed at step SB26. One song title among the list of song titles (for example, the first song title in the list of song titles) is highlighted, or displayed in color different from others at step SB27.

In the process for searching for a song title, for example, when only a character “A” is entered as shown in FIG. 8A, the prefix search process is executed to search for a song title starting with a character “A”, and a list of song titles starting with a character “A”, found in the prefix search process, is displayed on the display unit 3 as shown in FIG. 8B. In FIG. 8B, “AOI . . . ” means “Blue . . . ” in Japanese, “AKASAKA . . . ” is a name of a busy town in Tokyo, “ASAGAYA . . . ” is also a name of a town in Tokyo, and “ATARASHI . . . ” means “New . . . ” in Japanese. Meanwhile, when a character string of “AKA” is entered as shown in FIG. 8C, the partial match search process is executed to search for song titles including the character string of “AKA” somewhere therein. A list of searched song titles is displayed on the display unit 3 as shown in FIG. 8D.

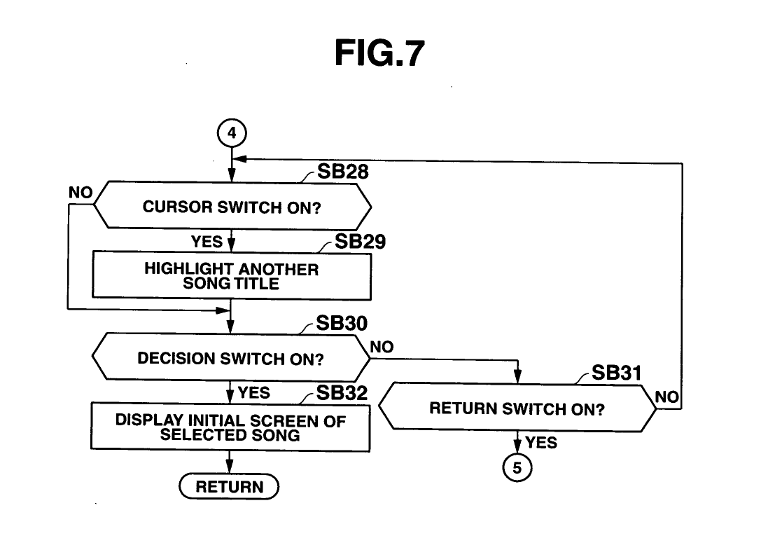

When the list of song titles has been displayed as shown in FIG. 8B or in FIG. 8D, it is judged at step SB28 in FIG. 7 whether or not the cursor switch 2d of the remote control device 1 has been operated. When the cursor switch 2d has been operated (YES at step SB28), another song title among the list of song titles is highlighted at step SB29. When the cursor switch 2d is not operated, or when the cursor switch 2d is operated whereby another song title is highlighted, it is judged at step SB30 whether or not the decision switch 2e has been operated. When it is determined at step SB30 that the decision switch 2e is not operated (NO at step SB30), it is judged at step SB31 whether or not the return switch 2f has been turned on. When the return switch 2f has been turned on (YES at step SB31), operation returns to step SB18 (FIG. 6), where the input screen for entering a song title is displayed on the display unit 3 again. When it is determined at step SB30 that the decision switch 2e has been operated (YES at step SB30), an initial screen of the selected song including the singer's name, song title, and a back ground image is displayed at step SB32, and operation returns to the main routine process shown in FIG. 3.

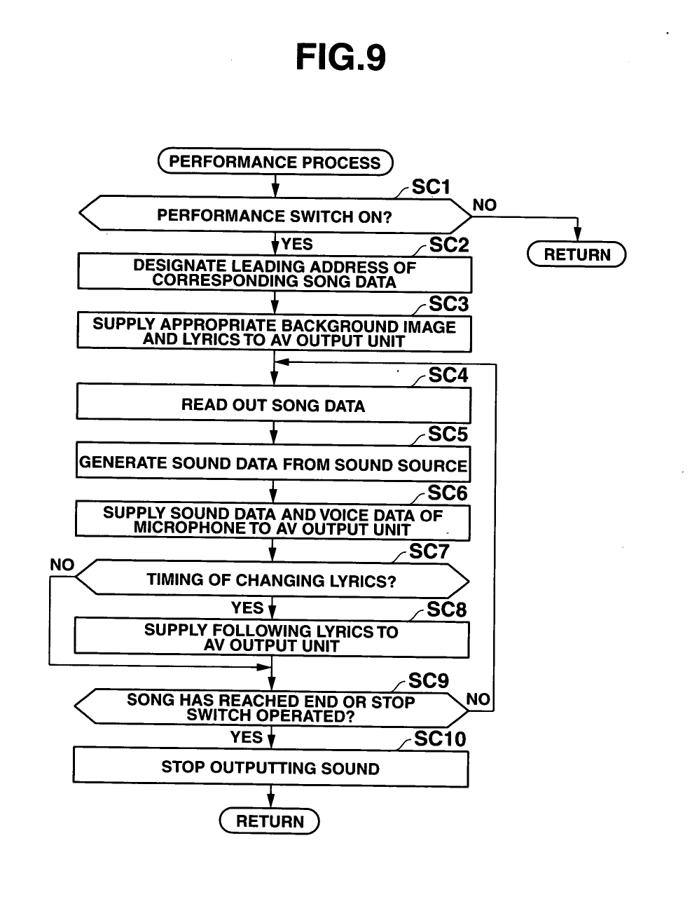

FIG. 9 is a flow chart of the performance process performed at step SA4 in the main routine process of FIG. 3.

It is judged at step SC1 whether or not the performance switch 2g has been turned on. When the performance switch 2ghas been turned on (YES at step SC1), the leading address of the corresponding song data is designated at step SC2. Then, the appropriate background image and lyrics are supplied to AV output unit 17 at step SC3. A process for starting reading out song data from the music data memory 15 is executed at step SC4, and sound data is generated based on the read out song data by the sound source 20 at step SC5. The generated sound data and a voice of the singer are supplied to AV output unit 17, and a sound is output from TV unit 19. As the song progresses, it is judged at step SC7 whether or not a timing at which lyrics is changed has been reached. When such timing has been reached (YES at step SC7), following lyrics data is read out from the music data memory 15, and the red out lyrics data is supplied to AV output unit 17 at step SC8. Thereafter, or when it is determined at step SC7 that the timing of changing lyrics has not yet been reached (NO at step SC7), it is judged at step SC9 whether or not the song has reached its end, or whether or not the performance stop switch 2h has been operated. When it is determined at step SC9 that the song has not yet reached the end and the performance stop switch 2h has not been operated (NO at step SC9), operation returns to SC4, where the process for reading out the song data is continued. When it is determined at step SC9 that the song has reached the end or the performance stop switch 2h has been operated (YES at step SC9), AV output unit 17 ceases outputting a sound at step SC10, and operation returns to the main routine shown in FIG. 3.

As described above, in the embodiment of the karaoke system of the present invention, upon switching operation of the remote control device 1, CPU 11 judges whether or not a single character has been entered to designate a singer's name or song title, or whether or not two and more characters have been entered to designate a singer's name or song title. When a single character has been entered, the prefix search process is executed to search for data to be retrieved based on the entered character. When two and more characters (character string) have been entered, the partial match search process is executed to search for information including the character string based on the entered character string.

Therefore, when searching for a singer's name or song title, the user is not required every searching operation to set whether to execute the prefix search or to execute a partial match search, and the user is allowed to search for his or her desired information simply by entering a single character.

As the embodiment of the information processing apparatus according to the present invention, the karaoke system has been described, but the information processing apparatus is not limited to the karaoke system. It will be apparent that the present invention will be applied to any other information processing apparatus in which a prefix search process or partial match search process is executed to search for information. Data to be entered for searching for information is not limited a character, but in the present invention, a numeral, symbol and/or their combination may be used in place of the character to execute a searching operation. In either case, when a single character, numeral, or symbol is entered, a prefix search process is executed to search for information starting with the entered character, numeral, or symbol, and when a series of two and more characters, numerals, or symbols, or their combination is entered, a partial match search process is executed to search for information including the series of characters, numerals, or symbols or their combination.

In the above description of the embodiment, the karaoke system has been described as an example of the information processing apparatus according to the present invention. It will be obvious that, according to the present invention, an arrangement may be possible such that a nonvolatile memory, such as a flash ROM and the like is provided in the information processing apparatus, and an information processing program recorded on CD-ROM, FD (flexible disc) and the like, or an information processing program downloaded through a network such as the internet is installed on the nonvolatile memory and CPU 11 executes the installed program.

More specifically, the above information processing program serves to make a computer judge whether entered data consists of any one of a single character, a single numeral and a single symbol, or the entered data consists of any one of a series of two and more characters, a series of two and more numerals, a series of two and more symbols, and a combination of a character, numeral, and symbol, and further to make the computer execute a prefix search process to search for information starting with one of the single character, single numeral, and single symbol, when it is determined that the entered data consists of one of a single character, a single numeral and a single symbol, and to make the computer execute a partial match search process to search for information including one of the series of characters, the series of numerals, the series of symbols, and the combination of a character, numeral, and symbol, when it is determined that the entered data consists of one of a series of two and more characters, a series of two and more numerals, a series of two and more symbols, and a combination of a character, numeral, and symbol.

Further, the program which is recorded on a recording medium for used with a karaoke apparatus having an input unit for entering either one of character data, numeral data and symbol data in response to operation of a user, a song data memory for storing plural song titles and plural pieces of song data corresponding to the song titles, the song title including either one of characters, numerals, symbols, and a combination of a character, numeral, and symbol, a sound source for generating a musical sound based on song data, a microphone for detecting an external voice, and an output unit for mixing the musical sound generated by the sound source and the voice detected by a microphone, whereby outputting the mixed audio sound, and the program, when installed on the karaoke apparatus, makes the karaoke apparatus (a) judge whether data entered from the input unit consists of any one of a single character, a single numeral and a single symbol, or the entered data consists of any one of a series of two and more characters, a series of two and more numerals, a series of two and more symbols, and a combination of a character, numeral, and symbol, (b) execute a prefix search process to search through the song data memory for a song title starting with one of the single character, single numeral, and single symbol, when it is determined that the data entered from the input unit consists of one of a single character, a single numeral and a single symbol, (c) execute a partial match search process to search through the song data memory for a song title including one of the series of characters, the series of numerals, the series of symbols, and the combination of a character, numeral, and symbol, when it is determined that the entered data consists of one of a series of two and more characters, a series of two and more numerals, a series of two and more symbols, and a combination of a character, numeral, and symbol, and (d) read out from the song data memory song data corresponding to the searched song title, and supplying the read out song data to the sound source.

What is claimed is:

1. An information processing apparatus comprising:
an input unit for entering either one of character data, numeral data and symbol data in response to operation of a user;
a judging unit for judging whether the data entered from the input unit consists of any one of a single character, a single numeral and a single symbol, or the entered data consists of any one of a series of two and more characters, a series of two and more numerals, a series of two and more symbols, and a combination of a character, numeral, and symbol; and
a searching unit for, when the judging unit determines that the data entered from the input unit consists of one of a single character, a single numeral and a single symbol, executing a prefix search process to search for information starting with one of the single character, single numeral, and single symbol, and for, when the judging unit determines that the entered data consists of one of a series of two and more characters, a series of two and more numerals, a series of two and more symbols, and a combination of a character, numeral, and symbol, executing a partial match search process to search for information including one of the series of characters, the series of numerals, the series of symbols, and the combination of a character, numeral, and symbol.

2. The information processing apparatus as defined in claim 1, wherein the judging unit judges the data entered from the input unit, when a decision command is entered through the input unit by user's operation.

3. The information processing apparatus as defined in claim 1, wherein the searching unit has a display unit for displaying the searched information.

4. The information processing apparatus as defined in claim 3, wherein the searching unit has a selecting unit for selecting one piece of information from among the plural pieces of information displayed on the display unit, when plural pieces of searched information are displayed on the display unit.

5. Karaoke equipment comprising:
a song data memory for storing plural song titles and plural pieces of song data corresponding to the song titles, the song title including either one of characters, numerals, symbols, and a combination of a character, numeral, and symbol;
an input unit for entering either one of character data, numeral data and symbol data in response to operation of a user;
a judging unit for judging whether the data entered from the input unit consists of anyone of a single character, a single numeral and a single symbol, or the entered data consists of any one of a series of two and more characters, a series of two and more numerals, a series of two and more symbols, and a combination of a character, numeral, and symbol; and
a searching unit for, when the judging unit determines that the data entered from the input unit consists of one of a single character, a single numeral and a single symbol, executing a prefix search process to search through the song data memory for a song title starting with one of the single character, single numeral, and single symbol, and for, when the judging unit determines that the entered data consists of one of a series of two and more characters, a series of two and more numerals, a series of two and more symbols, and a combination of a character, numeral, and symbol, executing a partial match search process to search through the song data memory for a song title including one of the series of characters, the series of numerals, the series of symbols, and the combination of a character, numeral, and symbol;
a data reading unit for reading out from the song data memory song data corresponding to the song title found by the searching unit;
a sound source for generating a musical sound based on the song data read out by the data reading unit;
a microphone for detecting an external voice; and
an output unit for mixing the musical sound generated by the sound source and the voice detected by the microphone, whereby outputting the mixed audio sound.

6. The karaoke equipment as defined claim 5, wherein the judging unit judges the data entered from the input unit, when a decision command is entered through the input unit in response to user's operation.

7. The karaoke equipment as defined in claim 5, wherein the searching unit has a display unit for displaying the searched song title.

8. The karaoke equipment as defined in claim 7, wherein the searching unit has a selecting unit for selecting one song title from among the plural song titles displayed on the display unit, when plural searched song titles are displayed on the display unit.

9. A computer readable recording medium, on which a computer program is recorded, the computer program for making a computer execute a process, the process comprising:
judging whether the data entered from an input unit consists of any one of a single character, a single numeral and a single symbol, or the entered data consists of any one of a series of two and more characters, a series of two and more numerals, a series of two and more symbols, and a combination of a character, numeral, and symbol; and
executing a prefix search process to search for information starting with one of the single character, single numeral, and single symbol, when it is determined that the data entered from the input unit consists of one of a single character, a single numeral and a single symbol, and executing a partial match search process to search for information including one of the series of characters, the series of numerals, the series of symbols, and the combination of a character, numeral, and symbol, when it is determined that the entered data consists of one of a series of two and more characters, a series of two and more numerals, a series of two and more symbols, and a combination of a character, numeral, and symbol.

10. The computer readable recording medium, on which a computer program is recorded, as defined in claim 9, wherein the computer program makes the computer judge the data entered from the input unit, when a decision command is entered through the input unit in response to user's operation.

11. The computer readable recording medium, on which a computer program is recorded, as defined in claim 9, wherein the computer program makes the computer display the searched information on a display unit.

12. The computer readable recording medium, on which a computer program is recorded, as defined in claim 11, wherein the computer program makes the computer select one piece of information from among the plural pieces of information displayed on the display unit, when plural pieces of searched information are displayed on the display unit.

13. A recording medium on which a program is recorded, in a karaoke apparatus having an input unit for entering either one of character data, numeral data and symbol data in response to operation of a user, a song data memory for storing plural song titles and plural pieces of song data corresponding to the song titles, the song title including either one of characters, numerals, symbols, and a combination of a character, numeral, and symbol, a sound source for generating a musical sound based on song data, a microphone for detecting an external voice, and an output unit for mixing the musical sound generated by the sound source and the voice detected by a microphone, whereby outputting the mixed audio sound, the program, when installed on the karaoke apparatus, making the karaoke apparatus execute a process, the process comprising:
judging whether data entered from the input unit consists of any one of a single character, a single numeral and a single symbol, or the entered data consists of any one of a series of two and more characters, a series of two and more numerals, a series of two and more symbols, and a combination of a character, numeral, and symbol;
executing a prefix search process to search through the song data memory for a song title starting with one of the single character, single numeral, and single symbol, when it is determined that the data entered from the input unit consists of one of a single character, a single numeral and a single symbol;
executing a partial match search process to search through the song data memory for a song title including one of the series of plural characters, the series of plural numerals, the series of plural symbols, and the combination of a character, numeral, and symbol, when it is determined that the entered data consists of one of a series of plural characters, a series of plural numerals, a series of plural symbols, and a combination of a character, numeral, and symbol; and
reading out from the song data memory song data corresponding to the found song title, and supplying the read out song data to the sound source.

14. The recording medium on which a program is recorded, as defined in claim 13, wherein the program makes the karaoke apparatus judge the data entered from the input unit, when a decision command is entered through the input unit in response to user's operation.

15. The recording medium on which a program is recorded, as defined in claim 13, wherein the program makes the karaoke apparatus display the searched song title on a display unit.

16. The recording medium on which a program is recorded, as defined in claim 15, wherein the program makes the karaoke apparatus select one song title from among plural song titles displayed on the display unit, when plural searched song titles are displayed on the display unit.
